(19) United States
(12) Patent Application Publication
(10) Pub. No.: US 2004/0198339 A1
(43) Pub. Date: Oct. 7, 2004

(54) Selective multi-media broadcast of traffic information

(76) Inventor: Ronald Bruce Martin, Carol Stream, IL (US)

Correspondence Address: Docket Administrator (Room 3J-219), Lucent Technologies, Inc., 101 Crawfords Corner Road, Holmdel, NJ, 07733-3030, US

(21) Appl. No.: 10/256,848

(22) Filed: Sep. 27, 2002

(51) Int. Cl. H04Q 7/20

(52) U.S. Cl. 455/423; 455/414.1

(57) ABSTRACT

The present invention provides a method and apparatus to broadcast traffic information in a multi-media wireless communication system. The present invention provides alerts to users within a predetermined distance from the event and who are moving toward the event. The alerts of the present invention comprise audio, real-time video, maps, and the capability to be transferred to an operator for more detailed instructions.

### FIELD OF THE INVENTION

This invention relates generally to the field of wireless communication systems, and more particularly to the broadcast of information from wireless networks to wireless terminals.

### BACKGROUND OF THE INVENTION

Existing traffic information systems provide real-time information to drivers in a specific area. This is typically accomplished utilizing a series of low-power transmitters located along a roadway. When an event that might impact traffic occurs, the traffic information system broadcasts information via the low power transmitters near the event (e.g. accident or construction). The broadcast consists only of audio and is received by a car's radio.

This information can be confusing to someone not familiar with the area. The audio announcement of the event as well as alternative routes is distracting to drivers as they attempt to discern if the event will impact their travel and what would be the best alternative. In addition, the information is sent to all cars within the transmission pattern of the low-power transmitters. Unfortunately, this means that cars moving away from the event are notified as well as cars moving toward the event.

Therefore, a need exists for a method and apparatus that allows easily understood traffic information to be transmitted to drivers who have the potential to be impacted by the event.

### BRIEF SUMMARY OF THE INVENTION

The present invention provides a method and apparatus to allow traffic information to be sent in a multi-media format only to mobile stations within a predetermined distance of a traffic impacting event and that are moving toward the event. In accordance with an exemplary embodiment of the present invention, a remote network traffic sensing node determines the average normal traffic flow in a particular location. When the remote network traffic sensing node detects abnormal traffic flow, it institutes a multi-media session with a broadcast traffic control node and sends live video of the traffic impacting event to the broadcast traffic control node.

In a further exemplary embodiment of the present invention, the broadcast traffic control nodes first determines which mobile units subscribe to a broadcast traffic information service. The broadcast traffic control nodes also determines which of the subscribing mobile units are within a predetermined distance from the traffic impacting event and are moving toward the event. The broadcast traffic control node bridges a multi-media session to appropriate subscribing mobile stations. This session preferably comprises live video of the event, suggested alternative routes, and an audio explanation of the traffic impacting event. In addition, responsive to instructions from the mobile station, the broadcast traffic control node can redirect the multi-media session to another endpoint. For example, the user of a mobile station may request to be redirected to an operator for detailed alternate directions.

Advantageously, such an arrangement gives drivers real-time multimedia information concerning traffic-impacting events. In addition, this arrangement does not require the driver to be familiar with the area in which the event occurred. Further, the driver can select the form and format of the assistance they wish to receive.

### BRIEF DESCRIPTION OF THE SEVERAL VIEWS OF THE DRAWINGS

FIG. 1 depicts a wireless communication system in accordance with an exemplary embodiment of the present invention.

FIG. 2 depicts a remote network traffic sensing node apparatus in accordance with an exemplary embodiment of the present invention.

FIG. 3 depicts a broadcast traffic control node apparatus in accordance with an exemplary embodiment of the present invention.

FIG. 4 depicts a flowchart of a method for providing broadcast traffic information in a remote network sensing node in accordance with an exemplary embodiment of the present invention.

FIG. 5 depicts a flowchart of a method for providing broadcast traffic information in a broadcast traffic control node in accordance with an exemplary embodiment of the present invention.

FIG. 6 depicts a flowchart of a method for providing broadcast traffic information in a mobile station in accordance with an exemplary embodiment of the present invention.

### DETAILED DESCRIPTION OF THE INVENTION

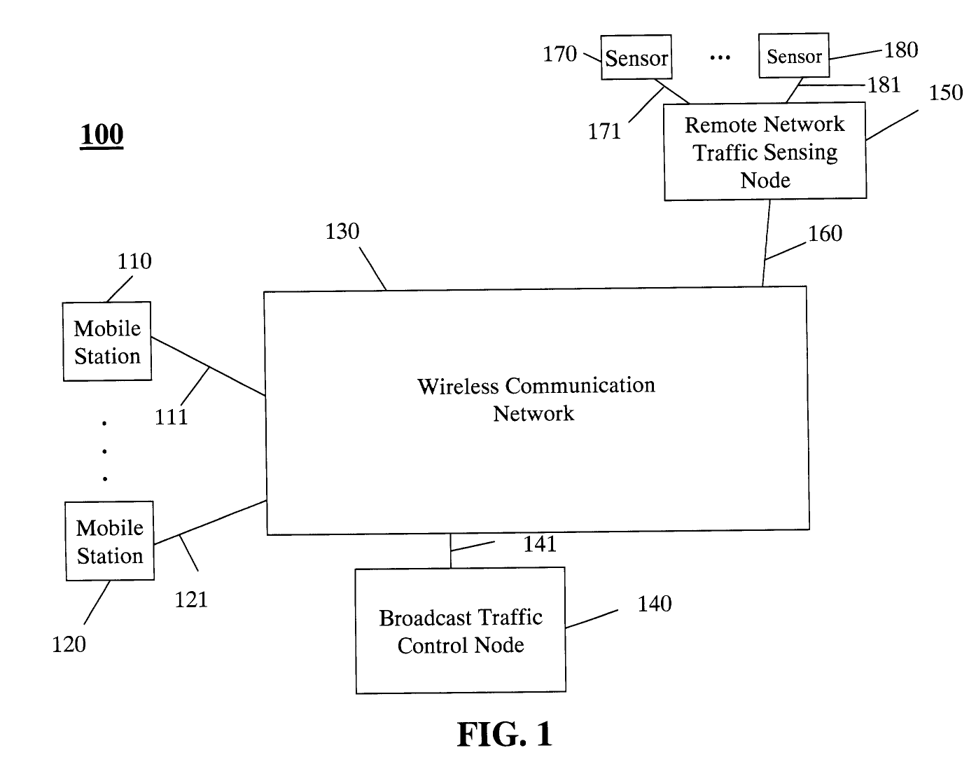

FIG. 1 depicts a wireless communication system 100 in accordance with an exemplary embodiment of the present invention. Wireless communication system 100 includes mobile stations 110 and 120, wireless communication network 130, broadcast traffic control node 140, remote traffic sensing node 150, and sensors 170 and 180. Wireless communication network 130 comprises functions necessary to operate and maintain wireless communications. Wireless communication network 130 can be based on any well-known technology, such as analog or digital.

Mobile stations 110 and 120 are coupled to a radio network interface (not shown) in wireless communication network 130 via links 111 and 121. Mobile stations 110 and 120 as well as links 111 and 121 can be based on any well-known technologies such as Time Division Multiple Access (TDMA) or Code Division Multiple Access (CDMA). Only a single block of communications network elements 130, radio network interface 150, two mobile stations 110 and 120, a single broadcast traffic control node 140, a single remote network traffic sensing node 150, and two sensors 170 and 180 are depicted in FIG. 1 for clarity. It should be understood that there may be a plurality of each of these elements in a typical communication system.

Mobile station 110 and mobile station 120 are coupled to and communicating with communication network 130. It should be understood that in an actual network a plurality of mobile stations are coupled to the communication network. As depicted in FIG. 1, mobile station 110 is communicating with communication network 130 via link 111. Mobile station 120 is communicating with communication network 130 via link 121. Links 111 and 121 can either be the same or different.

Broadcast traffic control node 140 is coupled to and communicating with communication network 130 via link 141. Link 141 can be based on any communication technology, such as digital, analog, wireless, or wireline. It should be understood that in an actual network a plurality of broadcast traffic control nodes are coupled to wireless communication network 130.

Remote network traffic sensing node 150 is coupled to and communicating with communication network 130 via link 160. Link 160 can be based on any known technology such as digital, analog, wireless, or wire line. It should be understood that in an actual network a plurality of remote traffic sensing nodes are coupled to wireless communication network 130.

Sensor 170 and sensor 180 are coupled to and communicating with remote network traffic sensing node 150. It should be understood that in an actual network a plurality of sensors are coupled to remote network traffic sensing node 150. As depicted in FIG. 1, sensor 170 is communicating with remote network traffic sensing node 150 via link 171. Sensor 180 is communicating with remote network traffic sensing node 150 via link 181. Links 171 and 181 can be based on any wireline or wireless technology. Links 171 and 181 can be the same or different.

In accordance with an exemplary embodiment of the present invention, sensors 170 and 180 each measure the volume of vehicular traffic passing a specific point. This can be done using transducers in the pavement that detect pressure or magnetic anomalies, an optical arrangement wherein a beam of light is broken by each passing vehicle, or any functionally equivalent arrangement. In the following description, sensor 170 will be used to explain the invention. Equivalently, sensor 180 could have been used.

Sensor 170 determines the current traffic flow rate for its assigned roadway and sends the current traffic flow rate information to remote traffic sensing node 150 via link 171. Sensor 170 can send an indication of the passage of each vehicle, sum the number of vehicles passing in a given time, or use any functionally equivalent method without loss of generality.

Remote traffic sensing node 150 receives the current traffic flow information from sensor 170. This flow information is then compared with historical data as to the normal traffic flow rate for this roadway based on various factors. The factors can include, but not limited to, the time of day and the day of the week. The historical data is stored in remote network traffic sensing node 150 and was generated, for example, by monitoring the input from sensor 170. Trigger points, or thresholds, associated with the actual flow of traffic versus the historical flow of traffic can also be stored in remote traffic sensing node 150 and used to indicate when a traffic impacting event has occurred.

When a traffic impacting event has occurred, remote network sensing node 150 initiates a multi-media session with broadcast traffic control node 140. Once the multi-media session is initiated, remote traffic sensing node 150 preferably begins transmitting a live video image of the traffic impacting event to broadcast traffic control node 140.

Broadcast traffic control node 140 accepts the multimedia session and determines the location of the traffic impacting event given the sensor that has initiated the session. A sensor is preferably dedicated to each direction of traffic flow at a location. This makes it possible to determine which direction of traffic flow is impacted.

Broadcast traffic control node 140 then determines which mobile stations might be impacted by the event. This can be done by determining the distance from the event of each subscribing mobile station as well as determining which of these mobile stations are moving toward the traffic impacting event. A subscribing mobile station is one that has elected to received this service from wireless communication network 130.

Broadcast traffic control node 140 then initiates a multi-media session to each of the mobile stations identified as being impacted by the event. These sessions are initiated via link 141. Link 141 can be based on any known technology such as digital, analog, wireless, or wireline. Utilizing a conference bridging function, broadcast traffic control node 140 can transmit live video of the event, audio explanation of the event, and suggested alternate routes. If requested by a particular mobile station, broadcast traffic control node 140 can redirect the session for that particular mobile station to a different end point. This different end point could be an operator position so that more detailed, interactive information can be provided to the mobile station. The multi-media sessions comprise a plurality of conference legs, and broadcast traffic control node 140 drops the conference legs at the end of the session.

Mobile stations 110 and 120 receive alerting for a traffic broadcast information multi-media session over links 111 and 121. Mobile station 110 will be used for explanation purposes without loss of generality. If mobile station 110 is engaged in an existing session or call, mobile station 110 places the existing session or call on hold and accepts the traffic broadcast information multimedia session. Mobile station 110 can continue to receive the session, terminate the, session, or request that broadcast traffic control node 140 redirect the call. Mobile station preferably indicates the desired disposition of the session by receiving input at mobile station 110 from a user of mobile station 110. This input can be received from the depression of a key on the keypad of mobile unit 110, by receiving a spoken command from a user of mobile station 110, or by any other means of receiving input from a user of mobile station 110.

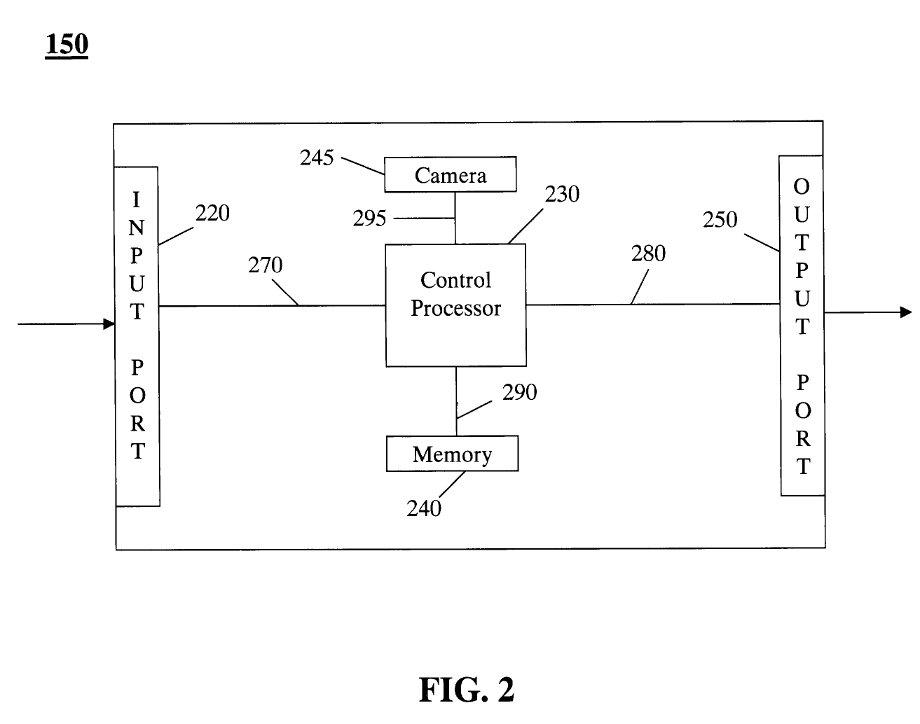

FIG. 2 depicts remote traffic sensing apparatus 150 in accordance with an exemplary embodiment of the present invention. Remote traffic sensing node 150 comprises input port 220, control processor 230, camera 245, memory 240, output port 250, and links 270, 280, 290, and 295. Control processor 230 may comprise a plurality of processors each with identical functions or with functions distributed among them by function type. A single control processor 230 is shown in FIG. 2 for clarity. Links 270, 280, 290, and 295 can be based on any known technology, such as an Ethernet bus.

In accordance with an exemplary embodiment of the present invention, input port 220 interfaces with sensors 170 and 180. Output port 250 interfaces with wireless communication network 130. Input port 220 receives measurement data from sensors 170 and 180. Output port 250 carries both bearer and control information between control processor 230 and wireless communication network 130. Output port 250 can be connected directly to wireless communication network 130 or to any network which can support multi-media sessions and can be connected to wireless communication network 130, such as a cable network.

Control processor 230 receives current traffic volume information from sensors 170 and 180. Control processor 230 interacts with memory 240 to determine traffic trigger levels, or thresholds, for sensors 170 and 180. If trigger levels have been exceeded, control processor 230 interacts with camera 245 and output port 250 to initiate a multi-media session with broadcast traffic control node 140. This multi-media session comprises sending video from camera 245 to broadcast traffic control node 140. When traffic levels return to levels below the trigger points, control processor 230 interacts with output port 250 to terminate the multi-media session.

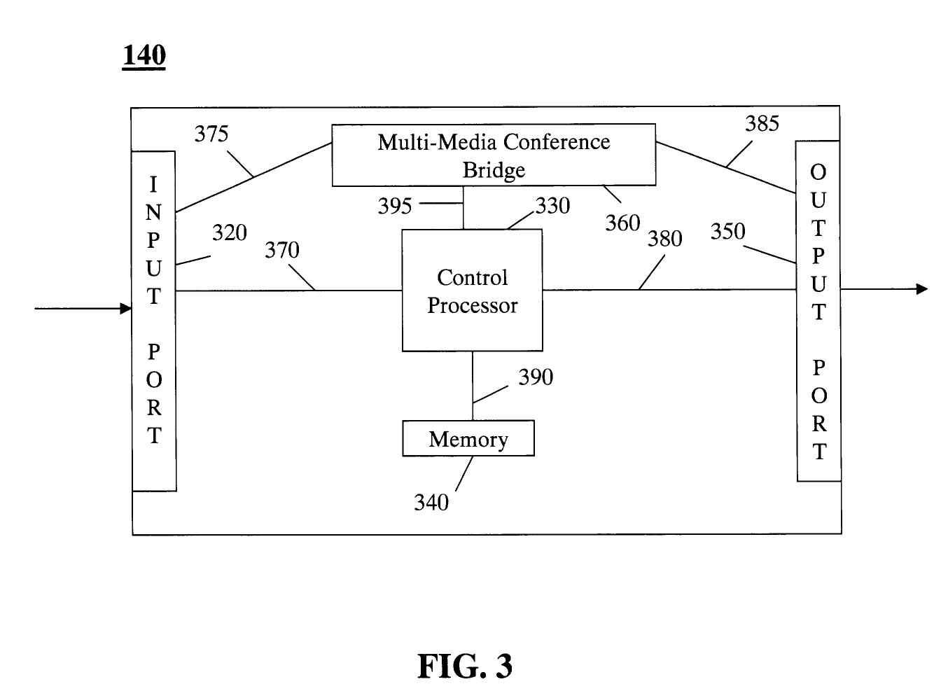

FIG. 3 depicts broadcast traffic control node 140 in accordance with an exemplary embodiment of the present invention. Broadcast traffic control node 140 comprises input port 320, control processor 330, memory 340, output port 350 multi-media conference bridge 360 and links 370, 375, 380, 385, 390, and 395. Control processor 330 may comprise a plurality of processors each with identical function or with functions distributed among them by function type. A single control processor 330 is shown in FIG. 3 for clarity. Links 370, 375, 380, 385, 390, and 395 can be based on any known technology, such as an Ethernet bus.

In accordance with an exemplary embodiment of the present invention, input port 320 and output port 350 interface with wireless communication network 130. Input port 320 and output port 350 carry both bearer and control information between control processor 330 and wireless communication network 130. Input port 320 and output port 350 can be connected directly to wireless communication network 130 or to any network which can support multi-media sessions and can be connected to wireless communication network 130, such as a cable network. Input port 320 and output port 250 can be located on the same physical link.

Control processor 330 receives alerting for multi-media sessions from remote sensing node 150. Control processor 330 interacts with memory 340 to determine which mobile stations are impacted by the event. This determination comprises control processor 330 determining the location and direction of movement of the mobile stations. This determination can be accomplished by a variety of techniques, including but not limited to cell and sector and Time Delay of Arrival techniques. Multiple applications of these or similar techniques will determine the location of a mobile unit at several points in time. This location data can then be analyzed to determine location, velocity, and direction of motion of the associated mobile station. Control processor 330 interacts with multi-media conference bridge 360 and output port 350 to establish multi-media sessions with mobile stations determined to be impacted by the event. The multimedia sessions preferably comprise video, audio, and still pictures. Control processor 330 drops the individual legs of the session when instructed to do so by the remote network traffic sensing node 150 or the individual mobile stations.

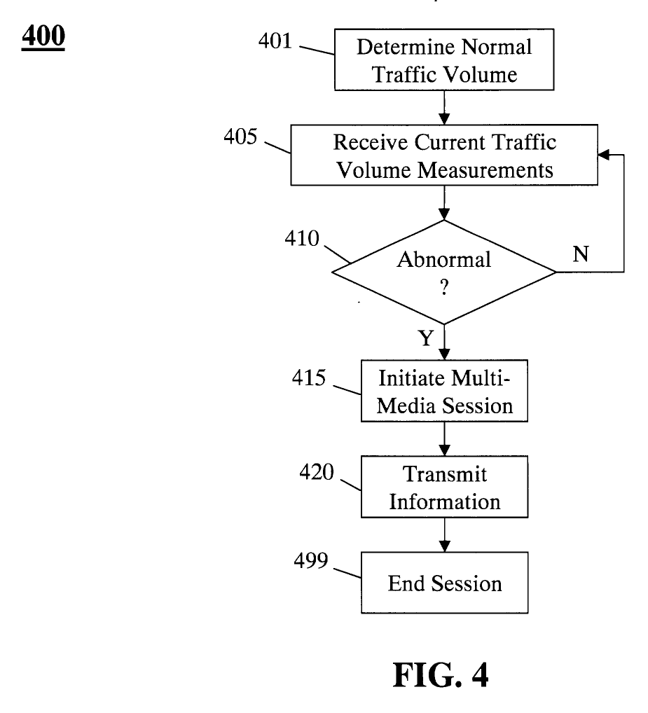

FIG. 4 depicts a flowchart 400 of a method for providing broadcast traffic information in a remote network traffic sensing node in accordance with an exemplary embodiment of the present invention.

Remote network traffic sensing node 150 determines (401) a normal traffic volume. This can be accomplished through the averaging of repeated measurements or by having this information pre-loaded in the remote network traffic sensing node memory. The normal traffic volume can fluctuate based upon the time of day or the day of the week. For example, during “rush hour” periods on a weekday, the normal traffic volume threshold will be higher than on a weekend or late at night.

Remote network traffic sensing node 150 receives (405) current traffic volume measurements from sensors 170 and 180. The measurements can be made by using transducers in the pavement that detect pressure or magnetic anomalies, an optical arrangement wherein a beam of light is broken by each passing vehicle, or any functionally equivalent arrangement.

Remote network traffic sensing node 150 decides (410) if the current traffic volume measurements indicates an abnormal traffic condition by comparing them to the normal traffic volume. This is accomplished by comparing current volume measurements to historical data stored in memory 240. If no abnormal condition exists, the remote traffic sensing node returns to receiving (405) current traffic volume measurements.

If an abnormal condition is detected at step 410, a multi-media session is initiated (415) with a broadcast traffic control node 140. The multi-media session initiation comprises sending an alerting indication over a control channel to the broadcast traffic control node.

Remote network traffic sensing node 150 transmits (420) video of the traffic impacting event to broadcast traffic control node 140. When measurements from sensors 170 and 180 indicate that the abnormal condition is no longer present, remote network traffic sensing node 150 ends (499) the session.

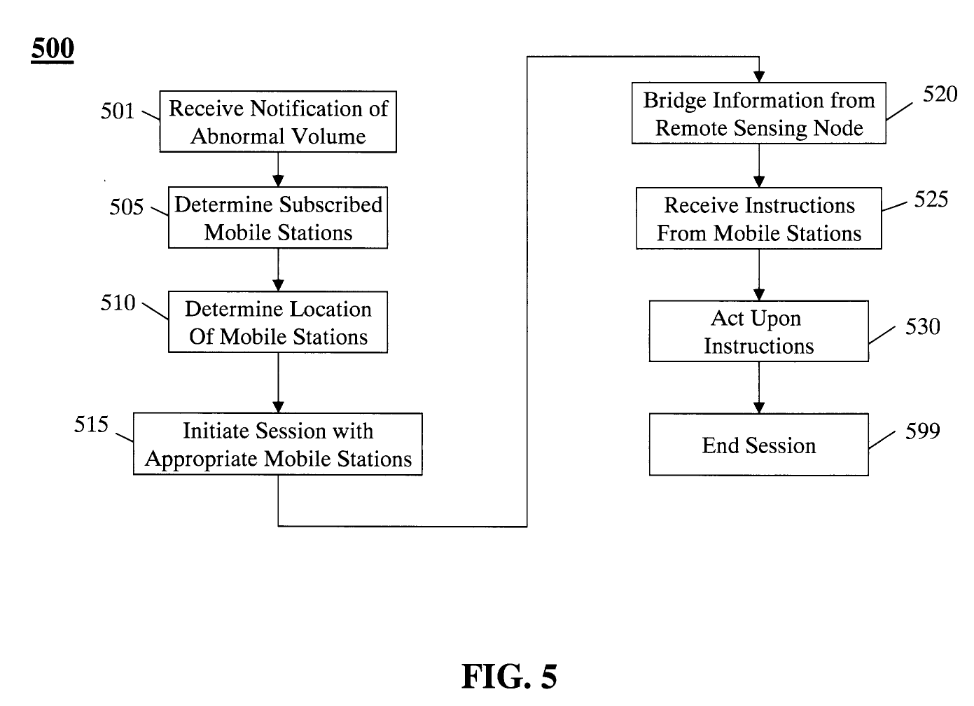

FIG. 5 depicts a flowchart (500) of a method for providing broadcast traffic information in a broadcast traffic control node in accordance with an exemplary embodiment of the present invention.

Broadcast traffic control node 140 receives (501) notification of an abnormal traffic volume. In accordance with an exemplary embodiment of the present invention, this notification comprises the initiating of a multi-media session from remote network traffic sensing node 150.

Broadcast traffic control node control processor 330 determine (505) what mobile units have subscribed to the broadcast traffic information service. This determination comprises retrieving a list of mobile units stored at the broadcast traffic control node 140. Broadcast traffic control node 140 knows the general location of the traffic impacting event based on the remote network traffic sensing node initiating the multi-media session.

Broadcast traffic control node control processor 330 determines (510) the location and direction of movement of the subscribed mobile stations. Techniques for this include but are not limited to cell and sector and Time Delay of Arrival techniques. Multiple applications of these or similar techniques can determine the location of the mobile unit at several points in time. This can then be analyzed to determine the location, velocity, and direction of motion of the mobile station.

Broadcast traffic control node 140 initiates (515) a multi-media session with mobile stations which are a predetermined distance from the event and are traveling toward the event. The multi-media session initiation comprises sending an alerting indication over a control channel to the appropriate mobile stations.

Broadcast traffic control node 140 bridges (520) event related information to the identified mobile stations 110 and 120. This is accomplished by utilizing the multi-media conference bridge 360 and includes bridging information from the remote traffic sensor node and other traffic related information that may be available from the local traffic authority or news media.

Broadcast traffic control node 140 may receive (525) instructions from mobile stations 110 and 120. These instructions include but are not limited to requesting a call redirection to an operator. Broadcast traffic control node 140 acts (530) on the instructions received from the mobile stations. The sessions end (599) as instructed by either remote network traffic sensing node 150 or mobile stations 110 and 120.

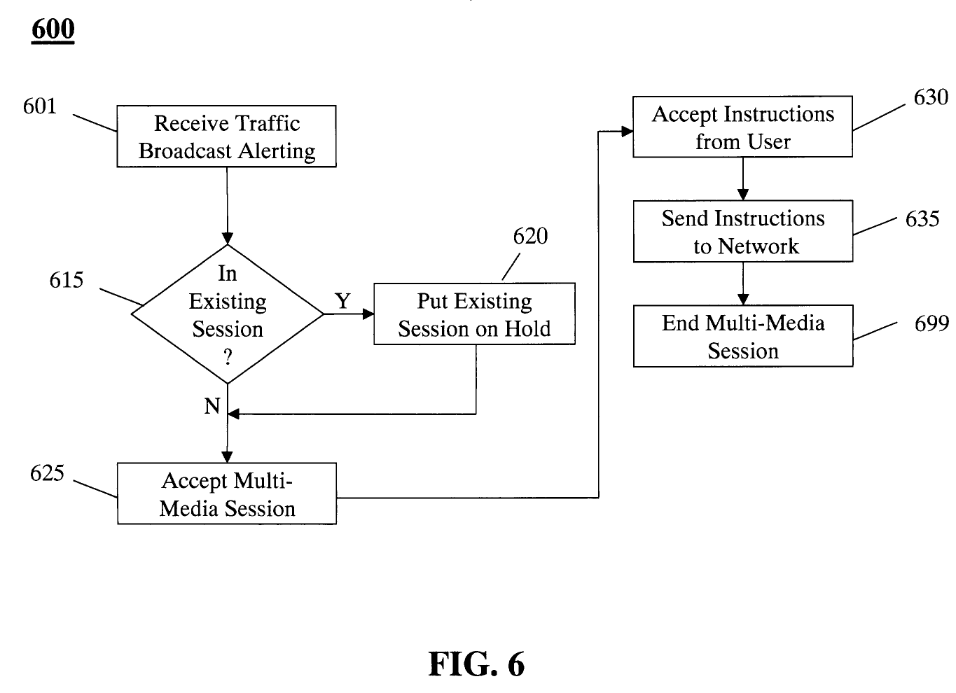

FIG. 6 depicts a flowchart (600) of a method for providing broadcast traffic information in a mobile station in accordance with an exemplary embodiment of the present invention.

Mobile stations 110 and 120 receive (601) alerting of an incoming broadcast traffic information session. Preferably, the alerting is received over a control channel.

Mobile stations 110 and 120 determine (615) if they are engaged in an existing session. If so, mobile stations 110 and 120 place (620) the existing session on hold. Preferably this is accomplished by keeping the existing session active and instituting a second session at the mobile station.

Mobile stations 110 and 120 accept (625) the incoming multi-media session. If a user wishes to input instructions, mobile stations 110 and 120 accept (630) instructions from the user. This can be done a variety of ways, including but not limited to entries on a key pad or speech recognition algorithms.

Mobile stations 110 and 120 send (635) instructions to wireless network 130. Preferably, these instructions are sent network over a control channel. These instructions include but are not limited to the requests for call redirection and termination of the session (699). Upon receiving a message to terminate the session, the multi-media session ends (699).

The present invention thereby provides a method and apparatus for providing selective multi-media broadcast of traffic information to selected mobile stations. By using the present invention, the network can provide useful, easily understood information concerning traffic-impacting events only to those mobile units whose direction of travel indicate that they might encounter the event.

While this invention has been described in terms of certain examples thereof, it is not intended that it be limited to the above description, but rather only to the extent set forth in the claims that follow.

I claim:

1. A method of providing broadcast traffic information in a wireless communication system, the method comprising the steps of:
determining a normal traffic pattern at a remote network traffic sensing node, the normal traffic pattern comprising an average range of vehicles per unit time during a period of unimpeded traffic flow;
detecting an abnormal traffic pattern at a remote network traffic sensing node, the abnormal traffic pattern comprising a value outside the range of the normal traffic pattern;
when the abnormal traffic pattern is detected, initiating a multimedia session between the remote network traffic sensing node and a broadcast traffic control node; and
transmitting real-time information concerning the abnormal traffic pattern over the multi-media session.

2. A method of providing broadcast traffic information in accordance with claim 1, further comprising ending the multimedia session after the abnormal traffic pattern has returned to the normal traffic pattern.

3. A method of providing broadcast traffic information in accordance with claim 1, wherein the step of detecting an abnormal traffic pattern comprises setting a trigger level indicating an abnormal traffic threshold at the remote traffic sensing node.

4. A method of providing broadcast traffic information in a wireless communication system, the method comprising the steps of:
receiving notification of an abnormal traffic pattern at a broadcast traffic control node;
retrieving a list of mobile stations subscribed to a broadcast traffic information service;
determining the locations of the mobile stations subscribed to the broadcast traffic information service; and
bridging a multimedia session from the remote network traffic sensing node to mobile stations subscribed to the broadcast traffic information service which are a predetermined distance from the remote traffic sensing node to form a bridged session.

5. A method for providing broadcast traffic information in accordance with claim 4, further comprising releasing the bridged session.

6. A method for providing broadcast traffic information in accordance with claim 4, further comprising determining the direction of motion of the mobile stations subscribed to the broadcast traffic information service.

7. A method for providing broadcast traffic information in accordance with claim 4, wherein the step of bridging a multimedia session comprises bridging the multimedia session from the remote sensing node to mobile stations subscribed to the broadcast traffic information service which are a predetermined distance from the remote sensing node and which are moving toward the remote sensing node.

8. A method for providing broadcast traffic information in accordance with claim 4, wherein the bridged session comprises a plurality of bridged legs, further comprising the step of ending the bridged session by dropping all bridged legs when the remote sensing node drops its connection.

9. A method for providing broadcast traffic information in accordance with claim 4, wherein the bridged session comprises a plurality of individual bridged legs, wherein each of the plurality of individual bridged legs is associated with one of the mobile stations, and further comprising the step of ending the bridged session by dropping individual legs as the individual mobile stations end their sessions.

10. A method for providing broadcast traffic information in accordance with claim 4, further comprising receiving instructions from one of the mobile stations subscribed to the broadcast traffic information service.

11. A method for providing broadcast traffic information in accordance with claim 10, further comprising redirecting the leg of the bridged session in accordance with the instructions received from the one of the mobile station subscribed to the broadcast traffic information service.

12. A method of providing broadcast traffic information in a wireless communication system, the method comprising the steps of:
receiving alerting of a incoming multimedia session from a broadcast traffic control node at a mobile station;
accepting the incoming multimedia session at the mobile station;
displaying multimedia input on a display of the mobile station; and
accepting instructions from an input device of the mobile station.

13. A method of providing broadcast traffic information in accordance with claim 12, further comprising the step of placing existing sessions on hold prior to accepting the incoming multimedia session.

14. A method of providing broadcast traffic information in accordance with claim 12, further comprising generating a request for call redirection in response to accepting instructions from a mobile station subscribed to the broadcast traffic information service.

15. A method of providing broadcast traffic information in accordance with claim 12, further comprising the step of releasing the multimedia session with the mobile station in response to the instructions from the mobile station subscribed to the broadcast traffic information service.

16. A Remote Network Traffic Sensing Node Apparatus for providing broadcast traffic information in a wireless communication system, the Remote Network Traffic Sensing Node Apparatus comprising:
an input port for receiving traffic information from at least one sensor;
a camera for providing multi-media video of the immediate area around the sensor;
a control processor for determining traffic trigger levels, comparing current traffic levels to the triggers, and initiating and terminating multi-media sessions;
a memory means for storing traffic trigger levels; and
an output port for sending the multi-media video to a broadcast traffic control node.

17. A Broadcast Traffic Control Node Apparatus for providing broadcast traffic information in a wireless communication system, the Broadcast Traffic Control Node Apparatus comprising:
an input port for receiving multi-media video from a remote traffic sensing node and instructions from mobile stations;
a multi-media conference bridge for broadcasting received multimedia video to a plurality of mobile stations;
a memory means for storing profile information of the mobile stations;
a control processor for determining target mobile stations for a particular broadcast, managing the multi-media conference bridge, accepting instructions from mobile stations, and redirecting specific conference legs; and
an output port for transmitting the multi-media video to target the mobile stations.
